(19) United States
(12) Patent Application Publication
(10) Pub. No.: US 2011/0141516 A1
(43) Pub. Date: Jun. 16, 2011

(54) DATA PROCESSING APPARATUS, IMAGE FORMING APPARATUS, AND CONTROL METHOD FOR CONTROLLING DATA PROCESSING APPARATUS

(75) Inventor: Hiroaki Niitsuma, Kawasaki-shi (JP)

(73) Assignee: CANON KABUSHIKI KAISHA, Tokyo (JP)

(21) Appl. No.: 12/948,612

(22) Filed: Nov. 17, 2010

(30) Foreign Application Priority Data
Dec. 11, 2009 (JP) 2009-281157

(51) Int. Cl. G06F 3/12

(52) U.S. Cl. 358/1.15

(57) ABSTRACT

A method for transferring image data to be transferred is switched depending on whether print setting is performed to image data transferred from a data processing apparatus. The the control method includes performing print setting to image data to be transferred to the image forming apparatus, determining whether the print setting is performed to the image data according as the data processing apparatus becomes communicable with the image forming apparatus, and controlling the data processing apparatus to transmit the image data and the print setting to the image forming apparatus in a case where it is determined that the print setting is performed, and transmit the image data to be printed according to the print setting set by the image forming apparatus to the image forming apparatus in a case where it is determined that the print setting is not performed.

### BACKGROUND OF THE INVENTION

1. Field of the Invention

The present invention relates to a data processing apparatus, an image forming apparatus, and a control method for controlling the data processing apparatus.

2. Description of the Related Art

There is an image processing apparatus (e.g., a printer) which is connected with an external device via a cable or wireless communication, acquires image data from the connected external device, and performs printing. As an external device to be connected, there is a data processing apparatus such as a digital camera in which an optical image is converted to digital data and the digital data is recorded, or a storage device for storing an image.

A cable communication is faster than a wireless communication, however, in recent years, not only a conventional wireless communication using a radiation field, but also a high-speed near field wireless communication technique using an induction field has been put into practical use.

An interface using such a high-speed near field wireless communication technique can transfer data between devices in a non-contact manner, which eliminates the need for requesting a user to do troublesome work such as the connection of a digital camera to a printer with a cable. Therefore, the interface is useful.

Until now, in a print system in which an external device is connected with a printer, there has been known a print system in which a function is shared between the devices connected with each other to compensate the operability or the insufficient function of the one device, improving user-friendliness of the print system (refer to Japanese Patent Application Laid-Open No. 2004-23304, for example).

The print system discussed in Japanese Patent Application Laid-Open No. 2004-23304 shares its functions between a plurality of devices forming the print system, so that the print system is quite complicated in configuration for the user who is unskilled at handling the devices. As described above, the use of the near field wireless communication technique eliminates the need for requesting the user to do troublesome work such as the connection of a digital camera to a printer with a cable.

Even if a communication between the image processing apparatus and the data processing apparatus becomes easy, the user's operation of the image processing apparatus can not necessarily be easy.

For example, the following problems arise. A plurality of settings can be required, such as in which layout the image data transmitted from the data processing apparatus are printed and how many copies of the image data are required. If the plurality of settings is made using both of the data processing apparatus and the image processing apparatus, it is difficult for the user to determine that the setting should be made using either the data processing apparatus or the image processing apparatus.

For this reason, a method for setting print on the image data acquired from the data processing apparatus can be complicated or a desired print setting cannot be achieved.

### SUMMARY OF THE INVENTION

According to an aspect of the present invention, a data processing apparatus to wirelessly communicate with an image forming apparatus includes a setting unit, determining unit, control unit. The setting unit performs print setting to image data to be transferred to the image forming apparatus. The determining unit determines whether print setting is performed to the image data by the setting unit according as the data processing apparatus becomes communicable with the image forming apparatus. The control unit controls the data processing apparatus to transmit the image data and the print setting to the image forming apparatus in a case where the determining unit determines that the print setting is performed and transmit the image data to be printed according to the print setting set by the image forming apparatus to the image forming apparatus in a case where the determining unit determines that the print setting is not performed.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a print system.

FIGS. 2A and 2B illustrate a communication process in the print system.

FIG. 3 is a block diagram illustrating a configuration of an image input apparatus.

FIG. 4 is a block diagram illustrating a configuration of a printer.

FIGS. 5A and 5B are flow charts illustrating a data processing procedure for the print system.

FIG. 6 is a perspective view illustrating a configuration of the printer.

FIG. 7 illustrates in detail an example of a display unit and an operation unit of the printer.

FIGS. 8A and 8B are perspective views each illustrating an appearance of the image input apparatus.

FIGS. 9A and 9B illustrate an example of a UI displayed on the display unit.

FIG. 10 is a perspective view illustrating a communicative connection state of the print system.

FIGS. 11A and 11B illustrate an example of a UI displayed on the display unit.

FIGS. 12A and 12B illustrate an example of a UI displayed on the display unit.

FIGS. 13A and 13B are examples of a data communication processing of the print system.

FIGS. 14A and 14B are flow charts illustrating a data processing procedure for the print system.

FIG. 15 is an example of a communication processing of the print system.

### DESCRIPTION OF THE EMBODIMENTS

Various exemplary embodiments, features, and aspects of the invention will be described in detail below with reference to the drawings.

### [Configuration of Print System]

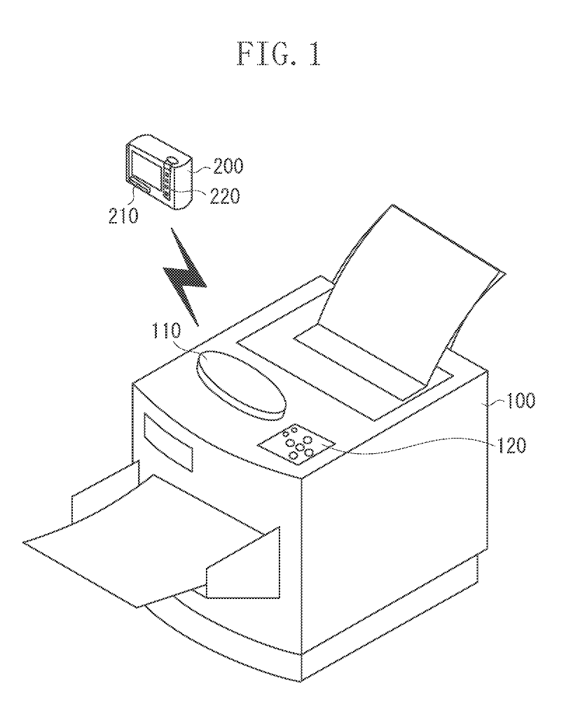

FIG. 1 illustrates a configuration of a print system according to the present exemplary embodiment. The present exemplary embodiment includes two types of apparatus such as a data processing apparatus and an image processing apparatus connected with each other via wireless network.

In the present exemplary embodiment, although an image input apparatus such as a digital camera is taken as an example of the data processing apparatus and a printer is taken as an example of the image processing apparatus, other apparatuses may be used. The present invention maybe applied to a PDA or a notebook personal computer, for example, instead of the digital camera, or applied to a Multi-Function Peripheral (MFP) instead of the printer.

As illustrated in FIG. 1, a printer 100 includes a communication unit 110 for wireless communication connected with an image input apparatus 200 by wireless communication, receives printing image data from the image input apparatus 200, and prints the printing image data. The image input apparatus 200 includes a communication unit 210 for wireless communication, similarly to the printer 100, transmits the printing image data to the printer 100 connected therewith by wireless communication.

A connection between the printer 100 and the image input apparatus 200 is established by the communication unit 110 of the printer 100 approaching the communication unit 210 of the image input apparatus 200. After the connection is established, the printer 100 and the image input apparatus 200 can transfer commands and data therebetween.

An operation unit 120 of the printer 100 receives the operation of the user and transmits the received operation as an operation command to the image input apparatus 200.

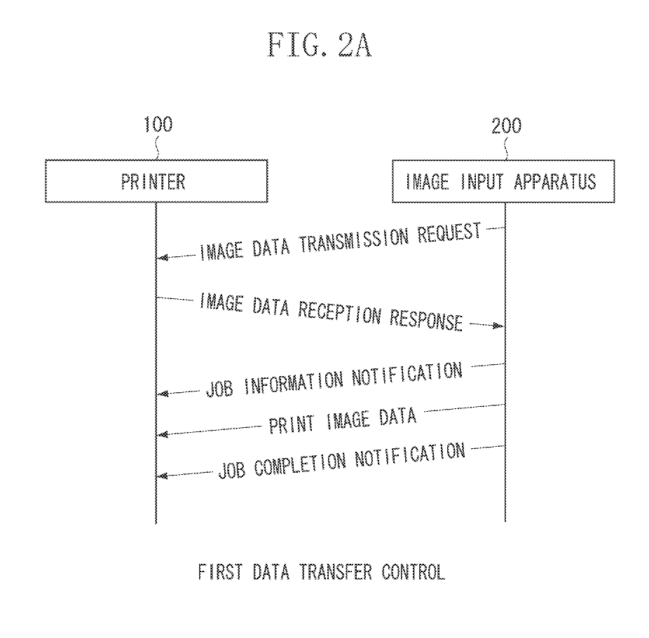

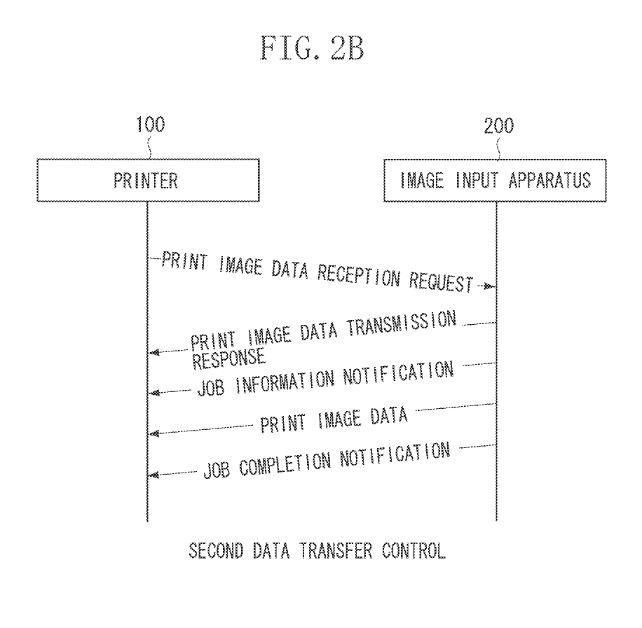

FIGS. 2A and 2B illustrate a communication processing between the printer 100 and the image input apparatus 200 in the print system illustrated in FIG. 1.

An example of a communication session illustrated in FIG. 2A corresponds to the procedure of a first data transfer control. The first data transfer control is performed in a case where the image input apparatus 200 is connected with the printer 100 in a state where the selection and the print setting of image data are performed to the image input apparatus 200 by the user.

The print setting is performed by an operation unit 220 of the image input apparatus 200 receiving the operation of the user. The image input apparatus 200 subjected to the print setting stands by for the transmission of set print image data.

In this case, the image input apparatus 200 transmits the selected image data and the print setting to the printer 100 in response to the image input apparatus 200 and the printer 100 being rendered to a communicable state.

More specifically, in FIG. 2A, the image input apparatus 200 continues transmitting an image data transmission request. On receiving the image data transmission request, the printer 100 transmits an image data reception response to the image input apparatus 200.

The image input apparatus 200 which receives the image data reception response determines that the image input apparatus 200 becomes communicable with the printer 100, and transmits information regarding the print image data as job information to the printer 100. Then, the image input apparatus 200 starts transmitting the print image data.

When the image input apparatus 200 completes transmitting the print image data, the image input apparatus 200 transmits a job completion notification to the printer 100. Then, the processing is ended.

Thus, the data transfer control for immediately transmitting the print image data to the printer 100 after the establishment of communication connection in a case where the image input apparatus 200 is previously subjected to the print setting is taken as the first data transfer control.

An example of a communication session illustrated in FIG. 2B corresponds to the procedure of a second data transfer control. The second data transfer control is performed in a case where the image input apparatus 200 is connected with the printer 100 in a state where the selection and the print setting of image data are not performed to the image input apparatus 200 by the user.

In this case, even if the image input apparatus 200 can communicate with the printer 100, the image input apparatus 200 stands by without transmitting the selected image data until receiving the transmission request from the printer 100.

Specifically, in FIG. 2B, after the image input apparatus 200 has become to be communicatable with the printer 100, the printer 100 transmits an image data reception request to the image input apparatus 200 in accordance with the user's instruction. On receiving the image data reception request, the image input apparatus 200 transmits an image data transmission response to the printer 100.

Thereafter, the image input apparatus 200 transmits information regarding the print image data as job information to the printer 100. The image input apparatus 200 starts transmitting the print image data.

When the image input apparatus 200 completes transmitting the print image data, the image input apparatus 200 transmits a job completion notification to the printer 100. Then, the processing is ended. Thus, the data transfer control for transmitting the print image data to the printer 100 in accordance with the user's instruction after the establishment of communication connection in a case where the image input apparatus 200 is not previously subjected to the print setting is taken as the second data transfer control.

As described above, the print system according to the present exemplary embodiment is characterized in that the first and the second data transfer control are switched depending on whether the image input apparatus 200 is subjected to the print setting when the communication is established, and the image data is transmitted.

### [Configuration of Image Input Apparatus]

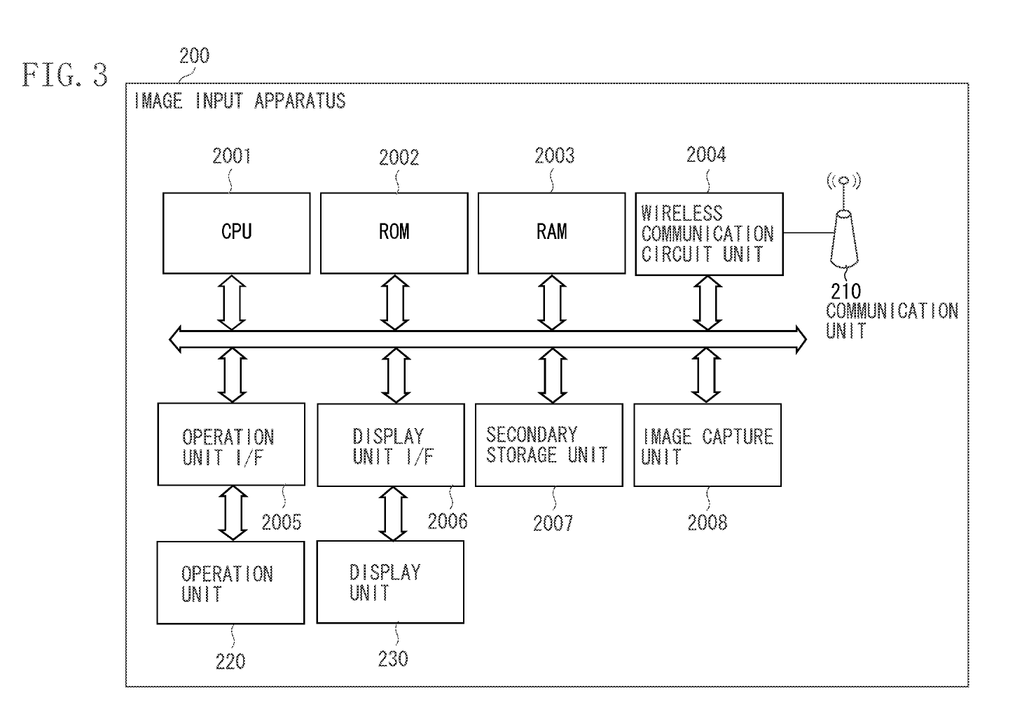

FIG. 3 is a block diagram illustrating a configuration of the image input apparatus 200 in FIG. 1.

The image input apparatus 200 includes a CPU 2001, a ROM 2002, a RAM 2003, a wireless communication circuit unit 2004, an operation unit I/F 2005, a display unit I/F 2006, a secondary storage unit 2007, and an image capture unit 2008.

In FIG. 3, the CPU 2001 is a processor for controlling the entire image input apparatus and operates according to the control program stored in the ROM 2002 to perform overall control of various processes.

The ROM 2002 is a non-volatile memory previously storing the control procedure of the image input apparatus 200. The RAM 2003 is a system work memory used for the operation of the CPU 2001, and is used as an area for temporarily storing various settings.

The RAM 2003 functions as a temporal buffer for data to be written in and read from the secondary storage unit 2007. The operation unit I/F 2005 is an interface for transmitting/receiving commands and data to and from an operation unit 220. The display unit I/F 2006 is an interface for transmitting/receiving commands and data to and from a display unit 230.

The secondary storage unit 2007 is a non-volatile memory previously storing images and setting information of the image input apparatus 200. The secondary storage unit 2007 may be an undetachable or a detachable replaceable media which is incorporated in the image input apparatus 200.

The image capture unit 2008 converts a captured optical image into digital data and stores image data in the secondary storage unit 2007. The wireless communication circuit unit 2004 includes a high frequency circuit unit, a coding and decoding circuit unit which are required for wireless communication, and a FIFO memory used for wireless communication, and is connected to the communication unit 210.

The wireless communication circuit unit 2004 communicates with the communication unit 110 of the printer 100 and transmits the image data stored in the image input apparatus 200 as print image data to the printer 100.

### [Configuration of Printer]

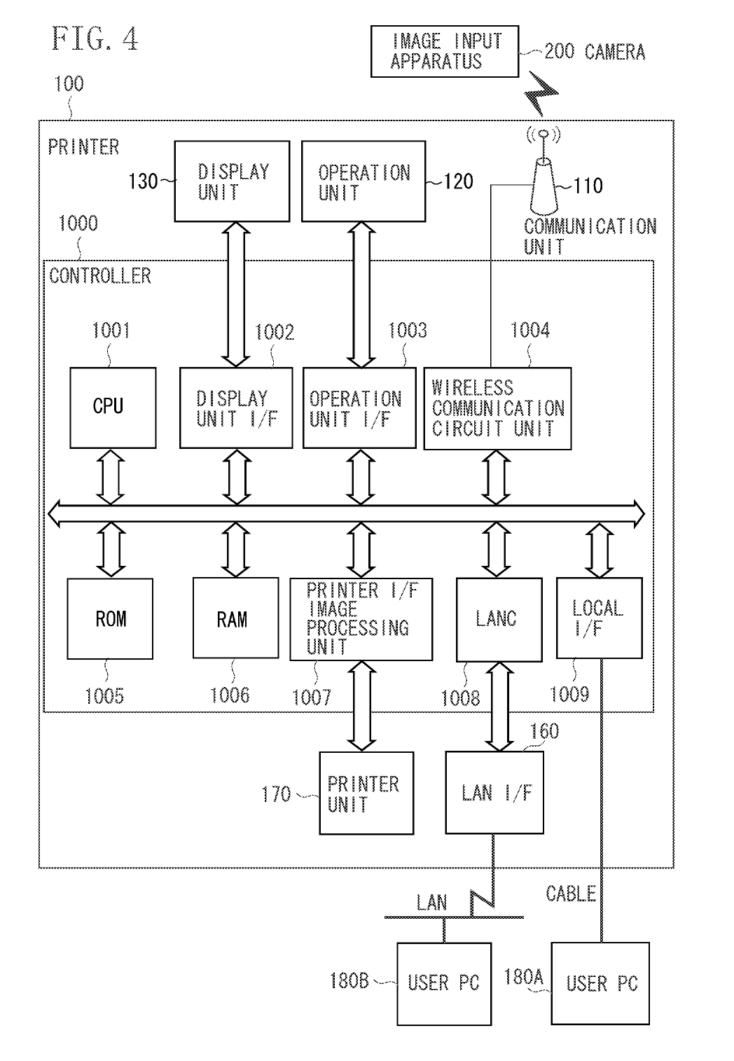

FIG. 4 is a block diagram illustrating a configuration of the printer 100 in FIG. 1.

A controller 1000 illustrated in FIG. 4 performs the image processing required for printing and the control of the entire printer 100. The controller 1000 includes a CPU 1001, a display unit I/F 1002, an operation unit I/F 1003, a wireless communication circuit unit 1004, a ROM 1005, a RAM 1006, a printer I/F image processing unit 1007, a LANC 1008, and a local I/F 1009.

The CPU 1001 is a processor for controlling the entire printer and operates according to the control program stored in the ROM 1005. The CPU 1001 also collectively controls various processes performed in the controller 1000. The RAM 1006 is a system work memory for the operation of the CPU 1001 and an image memory for temporarily storing image data.

The ROM 1005 is a boot ROM and a non-volatile memory storing the boot program of the system. The display unit I/F 1002 is an interface for transmitting/receiving commands and data to and from a display unit 130.

The operation unit I/F 1003 is an interface for transmitting/receiving commands and data to and from an operation unit 120. A LAN I/F 160 is connected to a LAN. The LANC 1008 inputs and outputs the print image data and information concerning the control of the printer from and to a user PC 180B.

The local I/F 1009 is a local interface such as USB, connected with the user PC 180B via a cable, and inputs and outputs the print image data and information concerning the control of the printer.

The printer I/F image processing unit 1007 performs image processing for print output on the print image data, and transmits print data to a printer unit 170 connected therewith.

The printer unit 170 prints based on the received print data and outputs a printed paper. A print method is based on an electro-photographic method using a photosensitive drum and a photosensitive belt.

The wireless communication circuit unit 1004 includes a high frequency circuit unit, a coding and decoding circuit unit which are required for wireless communication, and a FIFO memory used for wireless communication and is connected to the communication unit 110.

The communication unit 110 performs a short-distance wireless communication with the image input apparatus 200 as the above-mentioned external device communicating with the printer 100. The printer 100 receives the print image data from the image input apparatus 200. The printer I/F image processing unit 1007 performs image processing on the print image data for print output. Then, the printer 170 performs printing.

### [Control Flow of Print System]

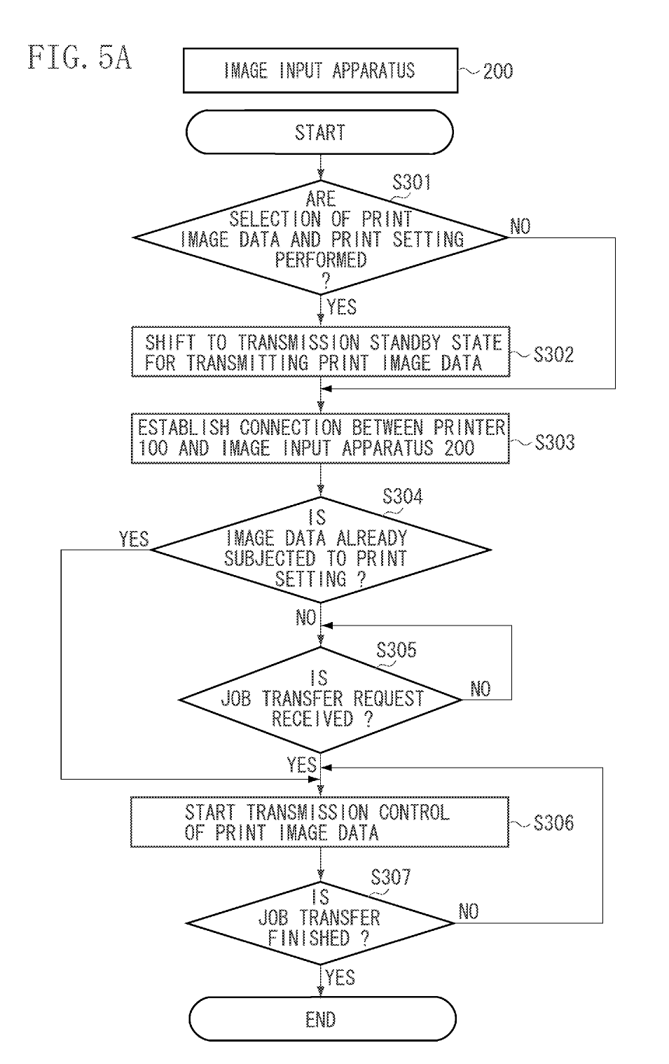

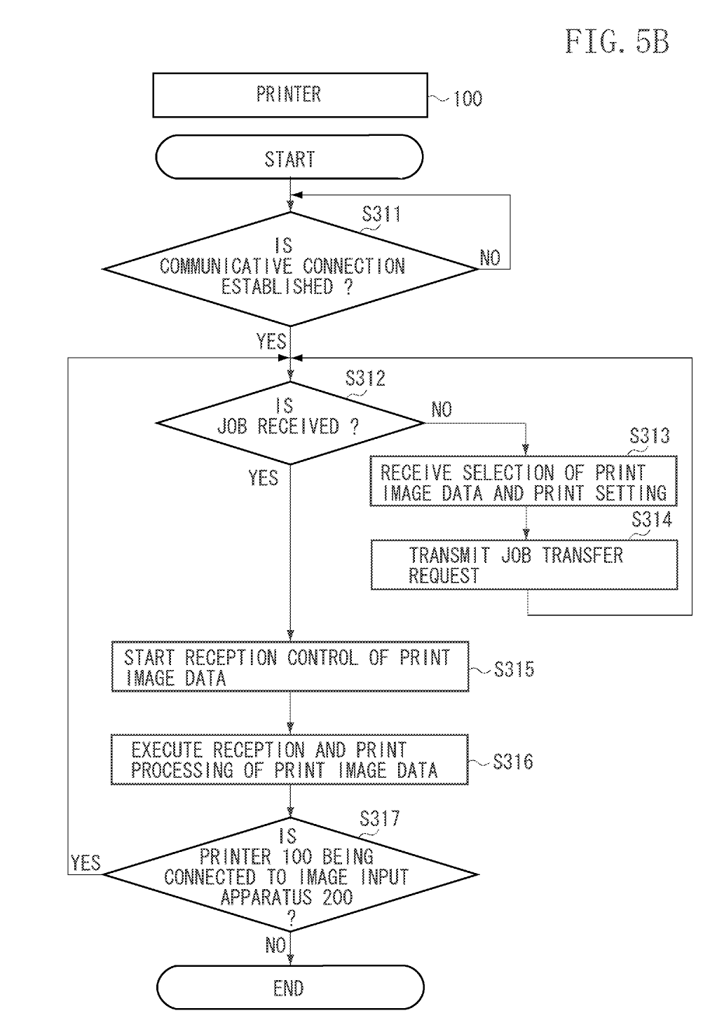

FIGS. 5A and 5B are flow charts illustrating an example of data processing procedure for the print system according to the present exemplary embodiment. The flow of FIG. 5A corresponds to the processing of the image input apparatus 200. The flow of FIG. 5B corresponds to the processing of the printer 100.

Steps S301 to S307 are realized by the CPU 2001 of the image input apparatus 200 illustrated in FIG. 3 loading the control program stored in the ROM 2002 into the RAM 2003, and executing the control program.

Steps S311 to S317 are realized by the CPU 1001 of the printer 100 illustrated in FIG. 4 loading the control program stored in the ROM 1005 into the RAM 1006, and executing the control program.

The user uses the user interface displayed on the operation unit 220 of the image input apparatus 200 to select print image data and perform the print setting of the print image data. In step S301, the CPU 2001 determines whether the selection and the print setting of print image data are input from the operation unit 220.

If the CPU 2001 determines that the selection and the print setting of print image data are not input from the operation unit 220 (NO in step S301), the processing proceeds to step S303.

On the other hand, if the CPU 2001 determines that the selection and the print setting of print image data are received from the operation unit 220 (YES in step S301), the processing proceeds to step S302. In step S302, the CPU 2001 is brought into a transmission standby state for transmitting the print image data, and the processing proceeds to step S303.

In step S303, if a communicative connection between the printer 100 and the image input apparatus 200 is established, in step S304, the CPU 2001 determines whether the first and the second data transfer control of the image input apparatus 200 are switched.

In step S304, the CPU 2001 determines whether the image data to be transferred by the image input apparatus 200 is already subjected to the print setting in step S302. The flow is separated based on the result of the determination.

In the present exemplary embodiment, the CPU 2001 of the image input apparatus 200 determines whether the print image data is subjected to the print setting after the communicative connection is established, and thereby the first and the second transfer control are switched. More specifically, “being subjected to the print setting” means a state where the image input apparatus 200 can start transmitting the image data to the printer 100, in other words, it means that the image input apparatus 200 is in a transmission standby state.

If the CPU 2001 determines that the print image data is subjected to the print setting (YES in step S304), in step S306, the CPU 2001 starts the first transfer control. The CPU 2001 transfers a job to the printer 100 based on the communication process in compliance with the procedure illustrated in FIG. 2A through wireless communication.

In step S307, the CPU 2001 determines whether the transfer of the job is finished based on the response from the printer 100. If the CPU 2001 determines that the transfer of the job is finished (YES in step S307), the processing is ended.

If the CPU 2001 determines that the transfer of the job is not finished (NO in step S307), the processing returns to step S306 to continue the transfer processing of the job.

If the CPU 2001 determines that the print image data is not subjected to the print setting (NO in step S304), in step S305, the CPU 2001 waits for the reception of a job transfer request from the printer 100, as illustrated in FIG. 2B. If the CPU 2001 receives the job transfer request from the printer 100 (YES in step S305), the CPU 2001 identifies the image data to be transferred. The processing proceeds to step S306 to start transferring the job.

The processing executed by the CPU 1001 of the printer 100 according to the flow chart illustrated in FIG. 5B is described below.

If a communicative connection between the CPU 1001 and the image input apparatus 200 is established (YES in step S311), the processing proceeds to step S312. In step S312, the CPU 1001 determines whether a job including the print image data is received from the image input apparatus 200 in compliance with the procedure illustrated in FIG. 2A through wireless communication.

If the CPU 1001 determines that the job is not received (NO in step S312), in step S313, the CPU 1001 receives the selection and the print setting of print image data which are input by the user operating the operation unit 120 of the printer 100.

In step S314, the CPU 1001 transmits a request for receiving the print image data to the image input apparatus 200 with wireless communication according to the procedure in FIG. 2B. Then, the processing returns to step S312.

In step S312, if the CPU 1001 determines that the content received from the image input apparatus 200 is a job (YES in step S312), the processing proceeds to step S315. In step S315, the CPU 1001 starts the control for receiving the print image data from the image input apparatus 200 in accordance with the procedure illustrated in FIG. 2A.

In step S316, the CPU 1001 executes print processing for the print image data received from the image input apparatus 200 through wireless communication. Thereby, the print image data received by way of both of the first and the second data transfer control are processed in the printer 170.

The contents to be processed may be not only the print processing for printing the print image data, but also the transfer processing for transferring the print image data to the user PC 180B via the LAN.

When the print image data is selected on the image input apparatus 200, the image input apparatus 200 may previously acquire information about the operation screen displayed on the operation unit 120 from the printer 100, store the information therein, and display it on the operation unit 220. In that case, when the user performs the print setting on the image input apparatus 200, the user can perform the print setting for the image data on the operation screen similar to that of the printer 100.

In step S317, the CPU 1001 determines whether the printer 100 is being connected to the image input apparatus 200. If the CPU 1001 determines that the printer 100 is being connected to the image input apparatus 200 (YES in step S317), the processing returns to step S312. If the CPU 1001 determines that the communication is cut off (NO in step S317), the processing is ended.

The communication between the image input apparatus 200 and the printer 100 can be cut off by the user only performing an operation for moving the image input apparatus 200 away from the communication unit 110 of the printer 100 by a predetermined distance.

The print system according to the present exemplary embodiment is described in detail below.

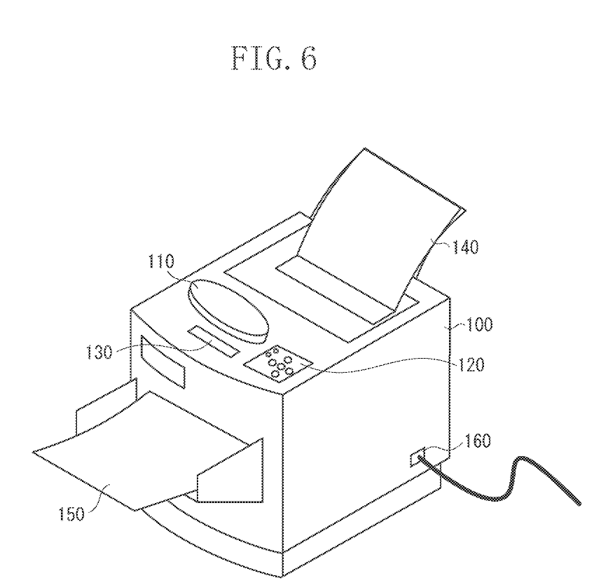

FIG. 6 is a perspective view illustrating an appearance of the printer according to the present exemplary embodiment. In FIG. 6, the printer 100 includes a display unit 130, an operation unit 120, a communication unit 110, and a LAN I/F 160.

The printer 100 receives a user's print job from the LAN I/F 160, performs printing on a paper fed from a paper feeding unit 140, and discharges the printed paper from a paper discharge unit 150.

The paper feeding unit 140 can be incorporated in the printer 100. If the printer 100 is provided with a plurality of paper feeding units, one of the paper feeding units is selected as the feeding unit and feeds a paper.

The communication unit 110 functions as a device port for performing the near field wireless communication whereby data and commands are exchanged between the printer 100 and an external device. The connection between the devices is established by moving the external device (including the image input apparatus 200) close to the communication unit 110 or attaching the external device thereto.

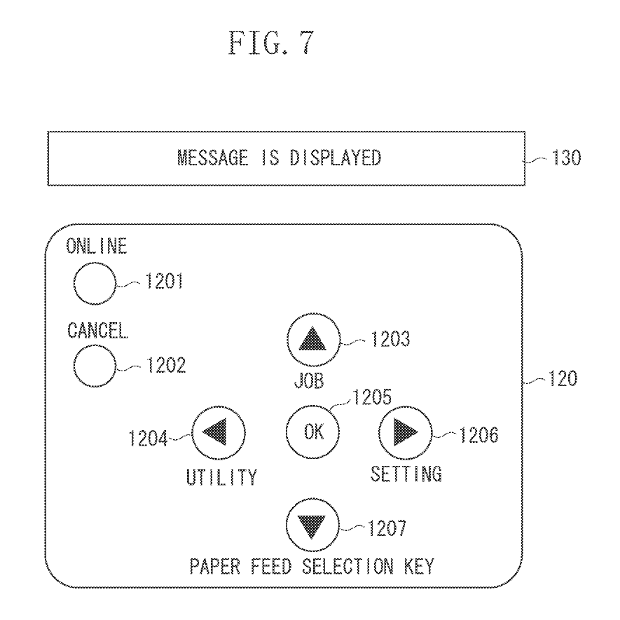

FIG. 7 illustrates an example of the display unit 130 and the operation unit 120 of the printer 100 illustrated in FIG. 6. In FIG. 7, the display unit 130 includes an LCD for displaying the current status of the printer 100 and the user's setting information.

The operation unit 120 includes a hard-key and receives user's input instructions. The hard-key of the operation unit 120 includes an online key 1201, a cancel key 1202, a job key 1203, a utility key 1204, an OK key 1205, a setting key 1206, and a paper feed selection key 1207.

The online key 1201 is a key for receiving the user's instructions concerning the connection of the printer 100 to the LAN and switching whether to communicate with the external device. The cancel key 1202 is a key for receiving the cancel of the job that the printer 100 is executing from the user.

The job key 1203 is a key for receiving instructions for displaying the history of a job in the printer 100. The utility key 1204 is a key for receiving instructions as to functions of the printer 100, such as the execution of test print, for example.

The OK key 1205 receives instructions for selection and determination. The setting key 1206 is a key for receiving instructions for print setting of the functions specific to the printer 100 such as two-sided printing and imposition of printing. The paper feed selection key 1207 is a key for receiving instructions for selecting where to feed paper.

The job key 1203, the utility key 1204, the setting key 1206, and the paper feed selection key 1207 are used as cursor keys for selecting items and moving upward, leftward, rightward, and downward respectively.

### [Appearance of Image Input Apparatus]

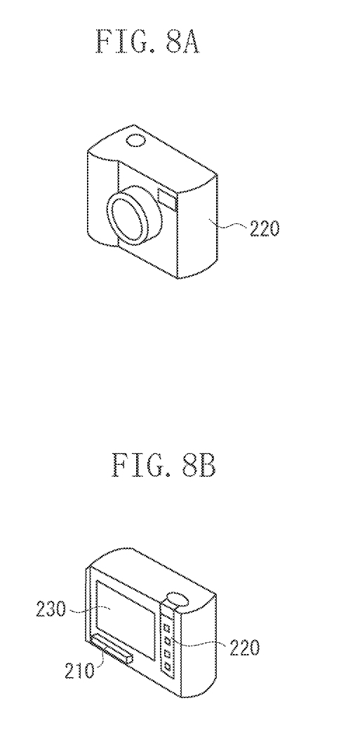

FIGS. 8A and 8B are perspective views illustrating the appearance of the image input apparatus 200 according to the present exemplary embodiment. In the present exemplary embodiment, a digital still camera is taken as an example of the image input apparatus 200. The image input apparatus 200 includes the operation unit 220, the display unit 230, and the communication unit 210.

As illustrated in FIG. 8A, an optical lens used for shooting is generally arranged on the front side of the main body. The operation unit 220 and the display unit 230, which are user interfaces, are arranged on the back side of the main body as illustrated in FIG. 8B.

The operation unit 220 includes a mode selection dial for selecting the operation mode of the image input apparatus 200, a menu key for calling menu items, a cursor key for instructing to select and move the menu items, and a shutter button for receiving instructions for photographing.

The display unit 230 displays the preview of image data stored in the image input apparatus 200 and the print setting concerning the print of image data. However, if the display unit 230 is constituted by a touch panel to allow receiving instructions from the user, the display unit 230 can also work as the operation unit 220.

The display unit 230 is also used as a finder at the time of shooting. The communication unit 210 communicates with the communication unit 110 of the printer 100.

### [Print Setting in Image Input Apparatus]

The print setting in the image input apparatus 200 is described below. The image input apparatus 200 can subject the image data stored in the secondary storage unit 2007 to various types of print settings.

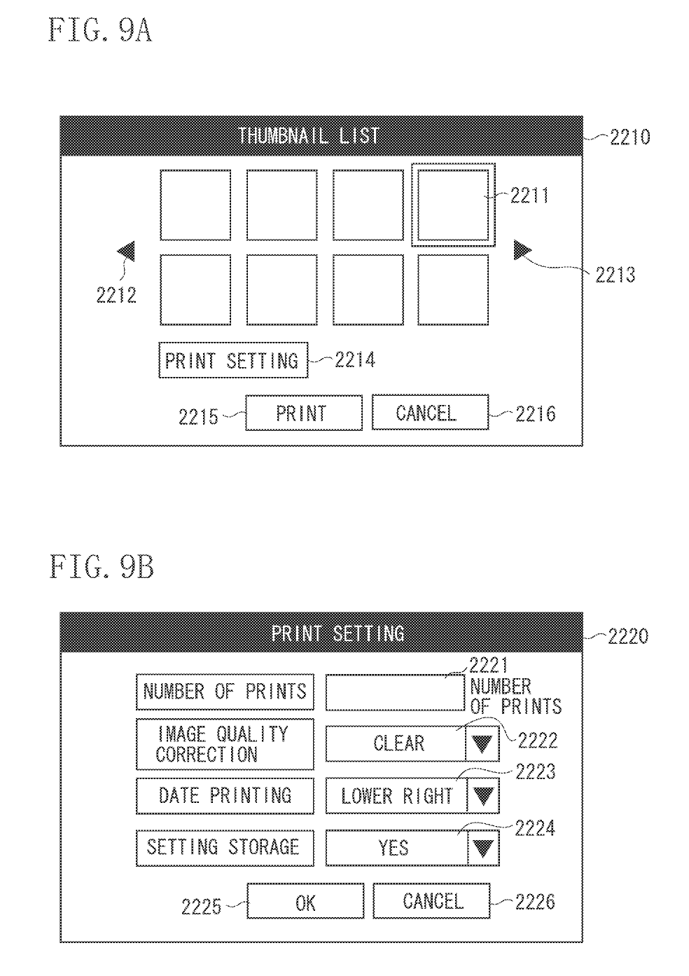

FIGS. 9A and 9B each illustrate an example of user interface displayed on the display unit 230 in FIG. 3. FIG. 9A illustrates an example where the CPU 2001 displays a thumbnail list screen 2210 of the image data stored in the secondary storage unit 2007 on the display unit 230. FIG. 9B illustrates an example of a screen for performing the print setting on the image data selected on the screen illustrated in FIG. 9A.

Eight thumbnails of image data are listed on the thumbnail list screen 2210 illustrated in FIG. 9A. The selected image data 2211 is highlighted. The operation of selection of an image is performed by the operation unit 220 receiving the user's instructions.

The selected image data 2211 can be enlarged and printed. Image data in addition to the listed eight thumbnails of image data can be stored in the secondary storage unit 2007. In the thumbnail list screen 2210, images before and after the currently displayed image are displayed by the user selecting a forward 2213 or rewind 2212 respectively.

The user selects a print setting button 2214 on the display unit 230 illustrated in FIG. 9A to display a print setting screen 2220 illustrated in FIG. 9B where a further detailed print setting is performed.

In FIG. 9B, the number of prints of the selected images is set on “the number of prints” 2221 on the print setting screen 2220. The contents of correction of print image quality are selected by the user on an “image quality correction” 2222. For “date printing” 2223, the user selects whether date is printed based on date information attached to the image data to be printed and selects the printing position of date.

A “setting storage” 2224 is selected in a case where the print setting set by the user is continuously stored even after printing as setting information of the print setting associated with the selected image. Depressing an OK button 2225 causes the CPU 2001 to enable the print setting selected on the print setting screen 2220, and perform control for returning the display of the display unit 230 to the thumbnail list screen 2210.

On the other hand, depressing a cancel button 2226 causes the CPU 2001 to disable the print setting selected on the print setting screen 2220, and perform control for returning the display of the display unit 230 to the thumbnail list screen 2210.

The user's selection of a “print” 2215 on the image input apparatus 200 causes the CPU 2001 to prepare the print image data for the image selected as an object to be printed according to the selected print setting. At this point, if the print image quality correction is selected with the image quality correction 2222, the CPU 2001 or an image processing unit (not illustrated) performs an image data correction processing.

The image input apparatus 200 is brought into a transmission standby state for transmitting jobs including the print image data and the print setting. The communication unit 210 stands by for wireless communication with the communication unit 110 of the printer 100.

If the connection between the image input apparatus 200 and the printer 100 is established while the communication unit 210 is standing by, the CPU 2001 starts the first data transfer control for performing a transmission request from the image input apparatus 200 to the printer 100.

[Communicative Connection between Printer and Image Input Apparatus]

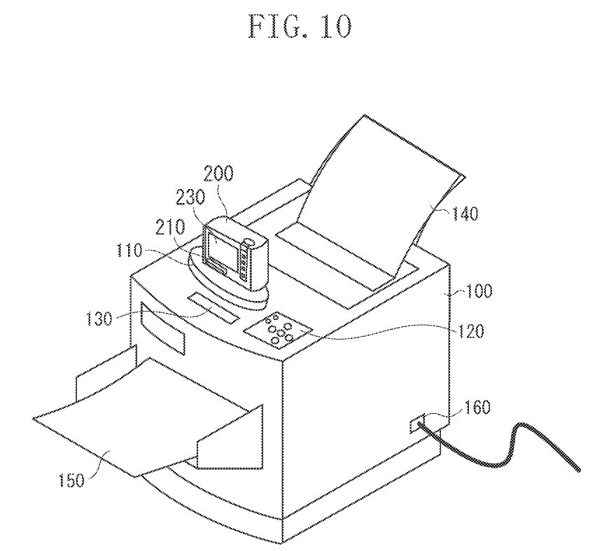

FIG. 10 is a perspective view illustrating a communicative connection state between the printer 100 and the image input apparatus 200 illustrated in FIG. 1.

In the present exemplary embodiment, the wireless communication connection between the printer 100 and the image input apparatus 200 is established by bringing the communication unit 210 of the image input apparatus 200 and the communication unit 110 of the printer 100, closer to each other, which are in a communicable state.

The communicable state in the above includes a state where the power supply of the image input apparatus 200 is energized, a communication mode is selected from among the operation modes of the image input apparatus 200, and image data are being previewed. The communicable state may be the one except for the above states.

The example in FIG. 10 illustrates that the image input apparatus 200 is placed on the communication unit 110 of the printer 100. If the user places the image input apparatus 200 thereon, there may be two cases where the image input apparatus 200 is placed thereon with the display unit 130 being visible and invisible.

The following display is performed so that the display unit 230 of the image input apparatus 200 faces the user who operates the printer 100.

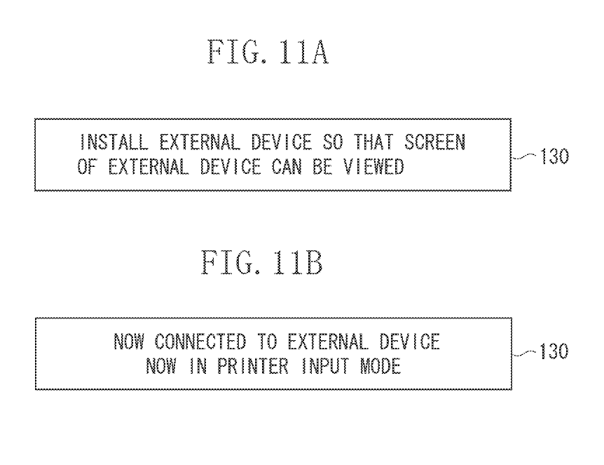

More specifically, as illustrated in FIG. 11A, the CPU 1001 of the printer 100 displays the message for notifying the user of the orientation of the image input apparatus 200 on the display unit 130. Furthermore, the CPU 1001 of the printer 100 displays the message illustrated in FIG. 11B on the display unit 130 to induce the user to appropriately set the orientation of the image input apparatus 200.

[Second Data Transfer Control between Printer and Image Input Apparatus]

The second data transfer control between the printer 100 and the image input apparatus 200 is described below.

The printer 100 in which communication is established with the image input apparatus 200 can issue an operation command to the image input apparatus 200 connected therewith. As illustrated in FIG. 11B, the display unit 130 displays the message to inform the user accordingly.

The CPU 1001 of the printer 100 receives the user's instructions via the operation unit 120 to issue an operation command to the image input apparatus 200. The operation command corresponds to the function indicated by the cursor key indicating the selection and the movement of menu items in the operation unit 220 of the image input apparatus 200.

Specifically, the operation unit 120 of the printer 100 can operate the image input apparatus 200 by receiving the user's instructions. Thereby, the image input apparatus 200 placed thereon does not need to directly receive the manual operation of the user, which does not prevent the image input apparatus 200 from being communicatively connected. This stabilizes the communication and reduces communication failure.

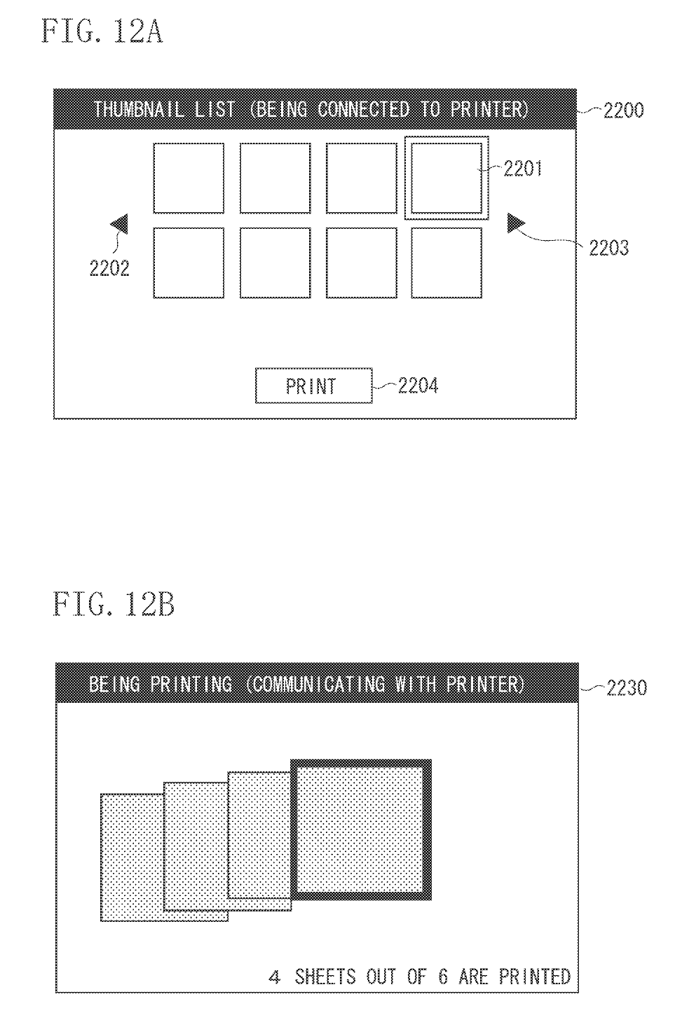

If communication is established between the image input apparatus 200 and the printer 100, the CPU 2001 is brought into a state where the CPU 2001 can receive the operation command from the printer 100. As illustrated in FIG. 12A, the CPU 2001 displays a thumbnail list screen 2200 of the image data stored in the secondary storage unit 2007 of the image input apparatus 200 on the display unit 230.

Eight thumbnails of image data are listed on the thumbnail list screen 2200 illustrated in FIG. 12A. The selected image data 2201 is highlighted.

The operation of selection of an image is performed by the image input apparatus 200 receiving the operation command from the printer 100. The selected image data 2201 can be enlarged and printed.

If image data in addition to the eight thumbnails of image data is stored in the secondary storage unit 2007, the following control is performed. In the thumbnail list screen 2200, images before and after the currently displayed image are displayed by receiving a forward 2203 and a rewind 2202 respectively as operation commands from the printer 100.

Thus, if a print button 2204 is selected by the user, the CPU 2001 of the image input apparatus 200 transmits the image data selected by the user to the printer 100 as the print image data through wireless communication.

When the printer 100 receives the print image data through wireless communication, the CPU 1001 starts the print processing of the received print image data. During the print processing, a user interface illustrated in FIG. 12B is displayed on the display unit 230 by the CPU 2001.

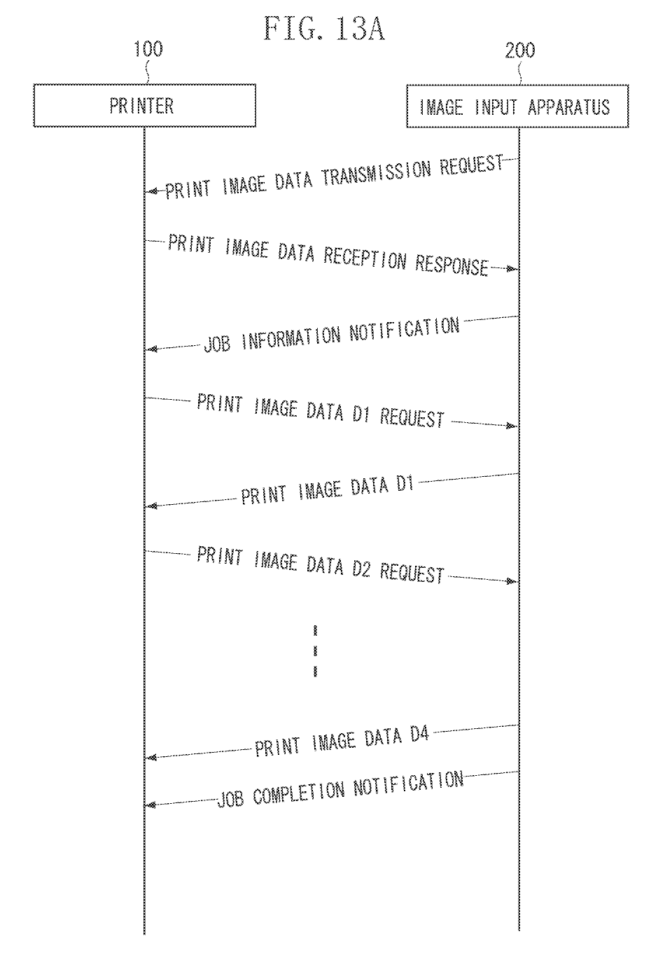

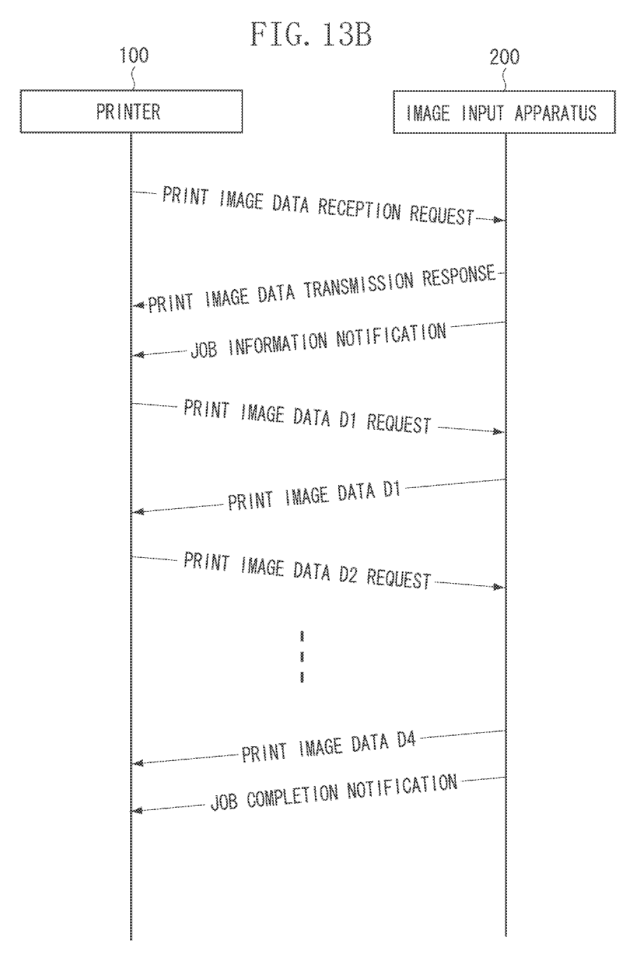

Response to transmitting and receiving of the print image data between the printer 100 and the image input apparatus 200 is described below with reference to FIG. 13A.

FIGS. 13A and 13B are examples of data communication processing of a print system according to the present exemplary embodiment. In the present exemplary embodiment, FIG. 13A is an example where the image input apparatus 200 transmits four image data as print image data D1, D2, D3, and D4.

[First Data Transfer Control between Printer and Image Input Apparatus]

The first data transfer control between the printer 100 and the image input apparatus 200 is described below.

When communication is established in a case where the print image data and the print setting are previously set, the CPU 2001 of the image input apparatus 200 immediately starts the transmission of the print image data set on the printer 100. When the printer 100 receives the print image data from the image input apparatus 200, the printer 100 starts the print processing of the received print image data.

Response to transmitting and receiving of the print image data between the printer 100 and the image input apparatus 200 is described below with reference to the communication state illustrated in FIG. 13A.

FIG. 13A is an example where the image input apparatus 200 transmits four image data as print image data D1, D2, D3, and D4.

In the first data transfer control, the CPU 2001 of the image input apparatus 200 transmits a print image data transmission request to the printer 100. The CPU 1001 of the printer 100 receiving the print image data transmission request sends back a print image data reception response to the image input apparatus 200.

The CPU 2001 of the image input apparatus 200 receiving the print image data reception response transmits job information related to the print image data.

The CPU 1001 of the printer 100 receiving the job information starts preparing for print, and requests the first print image data D1 from the image input apparatus 200. The CPU 2001 of the image input apparatus 200 receiving the request for the print image data D1 transmits the print image data D1 to the printer 100.

The CPU 1001 of the printer 100 receiving the print image data D1 performs printing, and requests the second print image data D2 from the image input apparatus 200. Thereafter, the CPU 1001 continues the above operation until the CPU 1001 receives the fourth print image data D4. The CPU 2001 of the image input apparatus 200 finally transmits a job completion notification to the printer 100 and ends response.

### [Second Data Transfer Control Between Printer and Image Input Apparatus]

In the second data transfer control, the CPU 1001 of the printer 100 transmits a print image data reception request to the image input apparatus 200 in accordance with the user's instruction. The CPU 2001 of the image input apparatus 200 receiving the reception request sends back a print image data transmission response to the printer 100, and successively transmits job information related to the print image data thereto.

The CPU 1001 of the printer 100 receiving the job information starts preparing for print, and requests the first print image data D1 from the image input apparatus 200. The CPU 2001 of the image input apparatus 200 receiving the request for the print image data D1 transmits the print image data D1 to the printer 100.

The CPU 1001 of the printer 100 receiving the print image data D1 performs printing, and requests the second print image data D2 from the image input apparatus 200. Thereafter, the CPU 1001 continues the above operation until the CPU 1001 receives the fourth print image data D4. The CPU 2001 of the image input apparatus 200 finally transmits a job completion notification to the printer 100 and ends response.

After that, the printer 100 prints the received image data. At this point, the printer 100 transmits display information indicating that a plurality of image data is being printed to the image input apparatus 200 to cause the display unit 230 of the image input apparatus 200 to display print status.

The user interface indicating that the printer 100 is performing printing, for example, illustrated in FIG. 12B, is displayed by the CPU 2001 on the display unit 230 of the image input apparatus 200.

Thus, the display unit 230 displays status 2230 where the printer 100 is currently printing, to notify the user of progress of printing. In general, the display unit 130 of the printer 100 is smaller in the amount of information to be displayed than the display unit 230 of the image input apparatus 200, and can also be lower in visibility than the display unit 230.

For that reason, using the display unit 230 of the image input apparatus 200 in operating the printer 100 can improve user-friendliness.

If the display unit 130 of the printer 100 is larger in display area than the display unit 230 of the image input apparatus 200, the screen illustrated in FIG. 12B may be displayed on the display unit 130 of the printer 100.

If the above control is performed, the printer 100 previously receives information indicating the size of the display area of the display unit 230 from the image input apparatus 200, compares the display area of the display unit 230 with that of the display unit 130 of the printer 100 to determine to display the screen in FIG. 12B on either display unit.

In the exemplary embodiment described above, after step S303 in FIG. 5A, if the CPU 2001 of the image input apparatus 200 determines that the print image data is subjected to the print setting, the CPU 2001 transmits the print image data to the printer 100.

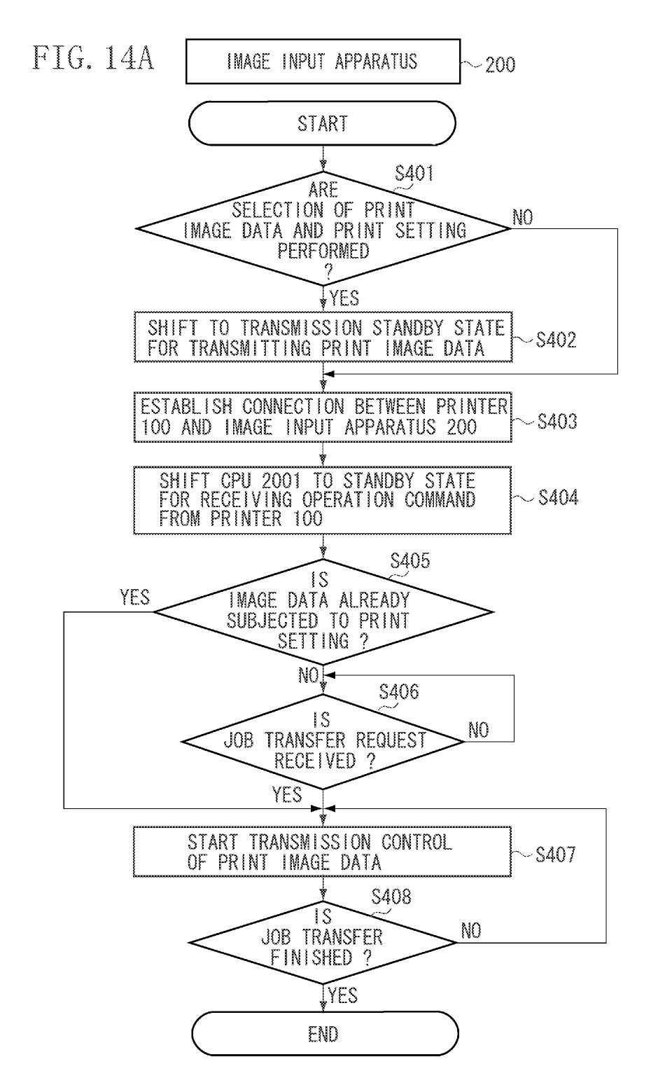

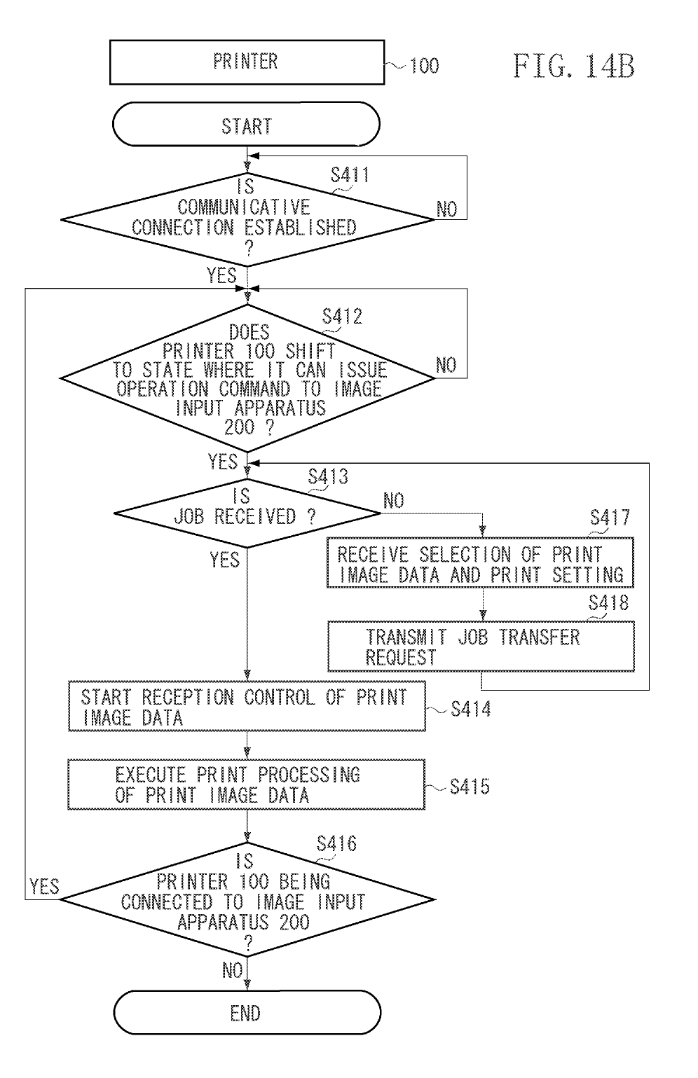

The image input apparatus 200 may be controlled so as to start the transfer processing of the print data after receiving the operation command such as a print instruction from the operation unit 120 of the printer 100. Such an exemplary embodiment is described below with reference to FIG. 14.

FIGS. 14A and 14B are flow charts each illustrating an example of data processing procedure for the print system according to the present exemplary embodiment. The flow of FIG. 14A corresponds to the processing for the image input apparatus 200. The flow of FIG. 14B corresponds to the processing for the printer 100.

Steps S401 to S408 are realized by the CPU 2001 illustrated in FIG. 3 loading the control program stored in the ROM 2002 into the RAM 2003 and executing the control program. Steps S411 to S418 are realized by the CPU 1001 illustrated in FIG. 4 loading the control program stored in the ROM 1005 into the RAM 1006 and executing the control program.

In step S401, the CPU 2001 of the image input apparatus 200 determines whether the selection and the print setting of print image data are performed on the thumbnail list screen 2210 illustrated in FIG. 9A. If the CPU 2001 determines that the setting is not performed (NO in step S401), the processing proceeds to step S403.

If the CPU 2001 determines that the selection and the print setting of print image data are performed (YES in step S401), the processing proceeds to step S402. In step S402, the CPU 2001 of the image input apparatus 200 is brought into a transmission standby state for transmitting the print image data. Then, the processing proceeds to step S403.

In step S403, if a communicative connection between the printer 100 and the image input apparatus 200 is established, the processing proceeds to step S404. In step S404, the CPU 2001 of the image input apparatus 200 is brought into a standby state for receiving the operation command from the printer 100. If the CPU 2001 receives the operation command from the printer 100, the processing proceeds to step S405.

In step S405, the CPU 2001 determines whether the print image data to be transferred to the printer 100 is already subjected to the print setting. If the CPU 2001 determines that the print image data is subjected to the print setting (YES in step S405), the processing proceeds to step S407 to start the first data transfer control.

If the CPU 2001 determines that the print image data to be transferred to the printer 100 is not yet subjected to the print setting (NO in step S405), the processing proceeds to step S406 to start the second data transfer control.

If the CPU 2001 of the image input apparatus 200 determines that the job transfer request is received (YES in step S406), according to the response in FIG. 13A, the processing proceeds to step S407. In step S407, the CPU 2001 starts the transmission control of the print image data to the printer 100. Then, the processing proceeds to step S408.

In step S408, the CPU 2001 determines whether the transfer of the job is finished based on the first or the second data transfer control. If the CPU 2001 determines that the transfer of the job is not finished (NO in step S408), the processing returns to step S407 to repeat the transfer of the job.

If the CPU 2001 determines that the transfer of the job is finished (YES in step S408), the processing is ended.

On the other hand, in the printer 100, if the CPU 1001 receives the print image data and the print setting selected by the user via the operation unit 120 of the printer 100 (YES in step S411), the processing proceeds to step S412. In step S412, the CPU 1001 determines whether the printer 100 is brought into a state where the printer 100 can issue the operation command to the image input apparatus 200.

If the CPU 1001 determines that the printer 100 is brought into a state where the printer 100 can issue the operation command (YES in step S412), the processing proceeds to step S413. The state where the printer 100 can issue the operation command to the image input apparatus 200 refers to a case where an error has not occurred in the printer 100.

If the printer 100 determines that an error has not occurred in the printer 100, the printer 100 determines that the printer 100 is brought into a state where the printer 100 can issue the operation command to the image input apparatus 200. The error refers to jam of printing paper, the failure of a storage unit, and the like.

In step S413, the CPU 1001 determines whether a job is received from the image input apparatus 200. If the CPU 1001 determines that a job is not received (NO in step S413), the proceeding proceeds to step S417 to receive the print image data and the print setting selected by the user via the operation unit 120. In step S418, the CPU 1001 transmits a job transfer request as the operation command to the image input apparatus 200. Then, the processing returns to step S413.

If the CPU 1001 determines that a job is received from the image input apparatus 200 (YES in step S413), the processing proceeds to step S414. In step S414, the CPU 1001 of the printer 100 starts reception control from the image input apparatus 200. In step S415, the CPU 1001 starts the print processing in which the printer unit 170 prints the print image data received from the image input apparatus 200.

If the CPU 1001 confirms that the print processing is completed, in step S416, the CPU 1001 determines whether communication is still established between the printer 100 and the image input apparatus 200. If the CPU 1001 determines that communication is no longer established between the printer 100 and the image input apparatus 200 (NO in step S416), the processing is ended.

The determination that communication is no longer established between the printer 100 and the image input apparatus 200 is made if the image input apparatus 200 is moved away from the communication unit 110 or the power supply of the image input apparatus 200 is turned off.

If the CPU 1001 determines that communication is still established between the printer 100 and the image input apparatus 200 (YES in step S416), the processing proceeds to step S412, where the CPU 1001 continues data communication processing with the image input apparatus 200.

The abovementioned control allows preventing image data from being received from the image input apparatus 200 if the printer 100 does not normally work due to the occurrence of an error.

The details of response between the printer 100 and the image input apparatus 200 are described below. In responses in FIGS. 13A and 13B, the image input apparatus 200 transmits the print image data in synchronization with the progress of printing in the printer 100.

The image input apparatus 200 transmitting the print image data in synchronization with the progress of printing in the printer 100 requires only the capacity of a buffer memory for a single image required for the spool of the print image data of the printer 100.

This allows reduction in the capacity of a buffer memory to be used. Even if the buffer memory of the printer 100 is small in capacity, a plurality of prints can be continuously made.

If the capacity of the buffer memory of the printer 100 can contain the capacity required for the process of the print job, the image input apparatus 200 can be configured so as to transmit at one time all print image data to be printed to the printer 100.

In that case, the print image data are first transmitted in synchronization with the progress of printing in the printer 100, and the rest of the print image data may be transmitted at one time in the middle of the job.

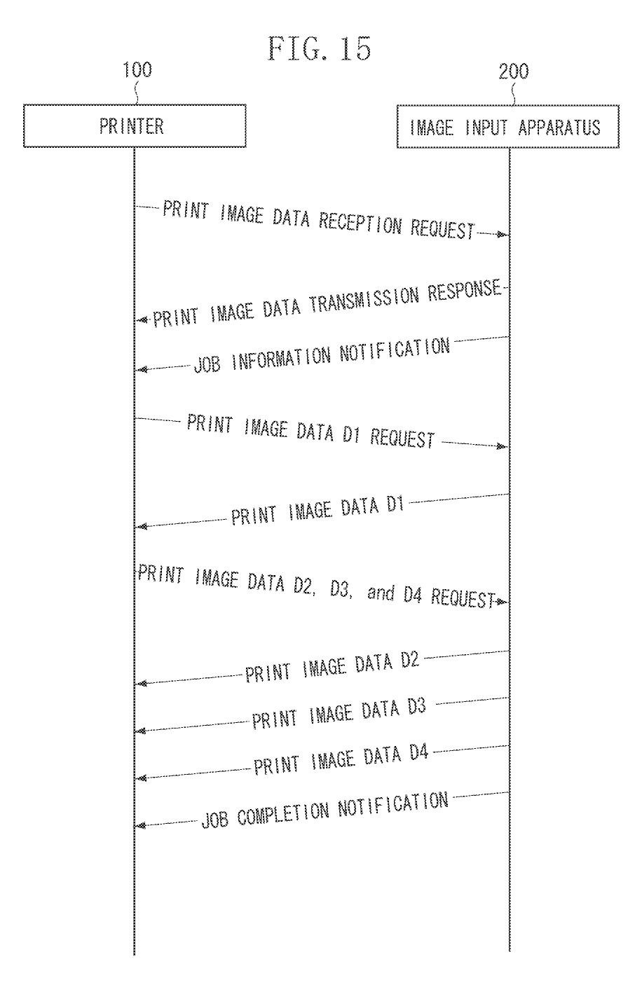

An example of response of the second data transfer control is described below with reference to FIG. 15.

FIG. 15 is a chart illustrating a communication process of the print system illustrated in FIG. 1. The present exemplary embodiment is an example where the image input apparatus 200 transmits four image data from a first print image data D1 to a fourth print image data D4 to the printer 100.

The CPU 1001 of the printer 100 first transmits a print image data reception request to the image input apparatus 200. The CPU 2001 of the image input apparatus 200 receiving the reception request sends back a print image data transmission response to the printer 100.

The CPU 2001 of the image input apparatus 200 successively transmits job information related to the print image data to the printer 100. The job information is the one related to the capacity and the print setting of the print image data to be transmitted by the image input apparatus 200.

The CPU 1001 of the printer 100 receiving the job information calculates the capacity of the print image data required for a spool from the received job information to determine whether the spool is possible.

If the CPU 1001 determines that the printer cannot spool all the rest of the print image data, the CPU 1001 transmits a request for print image data D1 to the image input apparatus 200. The CPU 2001 of the image input apparatus 200 receiving the request transmits the print image data D1 to the printer 100.

If the CPU 1001 of the printer 100 completes the print processing concerning a first print image data D1, the CPU 1001 determines whether the rest of the print image data can be spooled.

If the CPU 1001 determines that the rest of the print image data can be spooled, the CPU 1001 transmits a request for the rest of the print image data D2, D3, and D4 to the image input apparatus 200.

The CPU 2001 of the image input apparatus 200 receiving the request for the print image data D2, D3, and D4 sequentially transmits the print image data D2, D3, and D4 to the printer 100.

The CPU 1001 of the printer 100 sequentially receives the print image data D2, D3, and D4 from the image input apparatus 200, and executes the print processing. The CPU 2001 of the image input apparatus 200 transmits the print image data D4 and then notifies the printer 100 of the completion of the job. Then, the processing is ended.

In this case, the printer 100 completes the reception of all the print image data, so that the printer 100 can execute the print processing without interruption on the way even if communication is cut off between the printer 100 and the image input apparatus 200.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention. In an example, a computer-readable medium may have stored thereon, a program that causes at least one of a data processing apparatus and an image forming apparatus to perform a method described herein. In another example, a central processing unit (CPU) may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-281157 filed Dec. 11, 2009, which is hereby incorporated by reference herein in its entirety.

What is claimed is:

1. A data processing apparatus to wirelessly communicate with an image forming apparatus, the data processing apparatus comprising:
a setting unit configured to perform print setting to image data to be transferred to the image forming apparatus;
a determining unit configured to determine whether print setting is performed to the image data by the setting unit according as the data processing apparatus becomes communicable with the image forming apparatus; and
a control unit configured to control the data processing apparatus to transmit the image data and the print setting to the image forming apparatus in a case where the determining unit determines that the print setting is performed, and transmit the image data to be printed according to the print setting set by the image forming apparatus to the image forming apparatus in a case where the determining unit determines that the print setting is not performed.

2. The data processing apparatus according to claim 1, wherein the control unit starts a processing for transmitting the image data to the image forming apparatus according as the data processing apparatus becomes communicable with the image forming apparatus in a case where the determining unit determines that the print setting is performed to the image data, and starts processing for transmitting the image data in accordance with a request from the image forming apparatus in a case where the determining unit determines that the print setting is not performed to the image data.

3. An image forming apparatus to wirelessly communicate with a data processing apparatus, the image forming apparatus comprising:
a printing unit configured to print image data received from the data processing apparatus;
a determining unit configured to determine whether print setting is performed by the data processing apparatus after the image forming apparatus becomes communicable with the data processing apparatus; and
a control unit configured to receive the image data and print setting from the data processing apparatus in a case where the determining unit determines that the print setting is performed by the data processing apparatus, and cause a display unit to display an operation screen for receiving print setting for printing the image data by the printing unit in a case where the determining unit determines that the print setting is not performed by the data processing apparatus.

4. The image forming apparatus according to claim 3, wherein the control unit starts processing for receiving the image data from the image forming apparatus according as the data processing apparatus becomes communicable with the image forming apparatus in a case where the determining unit determines that the print setting is performed by the data processing apparatus, and transmits a request for transmitting the image data to the image forming apparatus in a case where the determining unit determines that the print setting is not performed to the image data.

5. A control method for controlling a data processing apparatus that wirelessly communicates with an image forming apparatus, the control method comprising:
performing print setting to image data to be transferred to the image forming apparatus;
determining whether the print setting is performed to the image data according as the data processing apparatus becomes communicable with the image forming apparatus; and
controlling the data processing apparatus to transmit the image data and the print setting to the image forming apparatus in a case where it is determined that the print setting is performed, and transmit the image data to be printed according to the print setting set by the image forming apparatus to the image forming apparatus in a case where it is determined that the print setting is not performed.
